(19) United States
(12) Patent Application Publication
(10) Pub. No.: US 2009/0056348 A1
(43) Pub. Date: Mar. 5, 2009

(54) MOTORIZED BALL VALVE CONTROL SYSTEM FOR FLUID COOLED HEAT EXCHANGER

(75) Inventors: Roger D. NOLL, Gahanna, OH (US); Gary HELMINK, Galloway, OH (US); Michael Jason GLOECKNER, Galena, OH (US); Russell C. TIPTON, Columbus, OH (US); Benedict J. DOLCICH, Westerville, OH (US)

Correspondence Address: LOCKE LORD BISSELL & LIDDELL LLP;ATTN: IP DOCKETING, 600 TRAVIS STREET, 3400 CHASE TOWER, HOUSTON, TX, 77002, US

(73) Assignee: LIEBERT CORPORATION, Columbus, OH (US)

(21) Appl. No.: 12/262,259

(22) Filed: Oct. 31, 2008

Related U.S. Application Data
(63) Continuation-in-part of application No. 11/832,176, filed on Aug. 1, 2007.

(51) Int. Cl. F25D 15/00; F25D 17/06; G05B 15/00

(52) U.S. Cl. 62/119; 62/190; 700/275

(57) ABSTRACT

A vapor compression cooling system having a control unit adapted to receive working fluid pressure or temperature, environment temperature or relative humidity, compressor digital output, or other cooling system information to control a condenser cooling fluid control valve to minimize flow changes through the valve.

### CROSS REFERENCE TO RELATED APPLICATIONS

The present application is a continuation-in-part of co-pending U.S. patent application Ser. No. 11/832,176, which was filed on Aug. 1, 2007, the contents of are incorporated herein by reference in its entirety.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The inventions disclosed and taught herein relate generally to a cooling system, and more specifically to a system and method of controlling a cooling system.

2. Description of the Related Art

In a conventional vapor compression cooling system, a compressor mechanically elevates the temperature and pressure of a vaporous working fluid to achieve a desired liquid state. A heat exchanger, typically designated as a condenser, transfers heat from the compressed working fluid to an environment or fluid. An expansion valve or other expansion device lowers the pressure of the condensed working fluid as it enters a second heat exchanger, typically designated as an evaporator, in which heat from the environment to be cooled is transferred to the working fluid. The heated working fluid returns to the compressor, and the cycle is repeated.

The condenser transfers heat from the working fluid (i.e, heat from the environment to be cooled) by transferring heat to another environment (e.g., outdoors) or to a cooling fluid (e.g., chilled water/condenser fluid). A typical chilled water condenser comprises a heat exchanger, and a fluid regulating valve. The condenser fluid picks up heat from the refrigerant flowing through the condenser and dumps the heat to the environment. The condenser fluid then flows through the regulating fluid valve and then back to the condenser. An alternate configuration would be to locate the valve after the condenser.

A vapor compression cooling system may be designed such that its heat removal (or cooling) capacity matches the heat load generated by the space that is being cooled. However, the heat load of the space to be cooled will vary according to various factors, including, for example, the season (outdoor temperature), equipment operating within the space, number of people present in the space, etc. To provide adequate cooling under all circumstances, conventional cooling systems are designed to have capacity equal to the maximum heat load of the space to be cooled. However, this will result in a cooling system with a capacity larger than required for most operating conditions. If the cooling system is operating at less than its rated capacity, the cooling system (e.g., refrigerant compressor) may cycle on and off repeatedly.

The inventions disclosed and taught herein relate to an improved cooling system, and a method and apparatus for controlling a cooling system.

### BRIEF SUMMARY OF THE INVENTION

In one aspect of the present invention, a method of controlling a vapor compression cooling system is provided, which comprises operating a vapor compression cooling cycle comprising a condensing heat exchanger; determining a pressure or temperature of a fluid leaving the condenser; determining when to change a valve position in response to the pressure or temperature to control a flow of cooling fluid through the condenser.

Another aspect of the present invention comprises a vapor compression cooling system having a vapor compression cooling cycle comprising a condenser and a working fluid; a condenser cooling cycle comprising a fluid control valve adapted to vary a cooling fluid flow through the condenser; a transducer associated with the condenser and adapted to transduce either pressure or temperature of the working fluid; and a controller adapted to determine when to vary the position of the fluid control valve in response to the transduced pressure or temperature.

### BRIEF DESCRIPTION OF THE SEVERAL VIEWS OF THE DRAWINGS

FIG. 1 illustrates one of many embodiments of a cooling system utilizing aspects of the present invention.

FIG. 2 is a chart that illustrates an exemplary embodiment of the bands in which the motorized ball valve of a vapor compression system operates.

FIG. 3 illustrates another embodiment of a vapor compression system utilizing aspects of the present invention.

FIG. 4 illustrates another embodiment of the operation of the fluid temperature adjustment factor of the valve position control routine.

FIG. 5 illustrates an embodiment of the operation of the digital output adjustment factor of the valve position control routine.

### DETAILED DESCRIPTION

The Figures described above and the written description of specific structures and functions below are not presented to limit the scope of what Applicants have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

Particular embodiments of the invention may be described below with reference to block diagrams and/or operational illustrations of methods. It will be understood that each block of the block diagrams and/or operational illustrations, and combinations of blocks in the block diagrams and/or operational illustrations, can be implemented by analog and/or digital hardware, and/or computer program instructions. Such computer program instructions may be provided to a processor of a general-purpose computer, special purpose computer, ASIC, and/or other programmable data processing system. The executed instructions may create structures and functions for implementing the actions specified in the block diagrams and/or operational illustrations. In some alternate implementations, the functions/actions/structures noted in the figures may occur out of the order noted in the block diagrams and/or operational illustrations. For example, two operations shown as occurring in succession, in fact, may be executed substantially concurrently or the operations may be executed in the reverse order, depending upon the functionality/acts/structure involved.

Computer programs for use with or by the embodiments disclosed herein may be written in an object oriented programming language, conventional procedural programming language, or lower-level code, such as assembly language and/or microcode. The program may be executed entirely on a single processor and/or across multiple processors, as a stand-alone software package or as part of another software package.

Applicants have created a system and method of controlling the fluid flow through a fluid cooled heat exchanger in a vapor compression cooling system. By controlling the fluid flow through the fluid cooled heat exchanger, the thermal capacity of the cooling system can be optimally controlled. The fluid flow and thus the thermal capacity of the cooling system, may be optimally controlled in at least two ways: (1) by controlling the amount of heat removed from the condenser by controlling the cooling fluid flow through the condenser and (2) by controlling the amount of heat removed from the condenser by adjusting the heat transfer area of the condenser. For example, increasing the cooling fluid flow through the condenser may increase the cooling capacity of the system because more heat can be transferred from the refrigerant to the cooling fluid. Alternately, increasing the heat transfer area, e.g., the condenser surface area, may increase the heat transferred from the refrigerant to the cooling fluid thereby increasing the capacity of the cooling system. It will be appreciated that the cooling capacity of the system can be reduced in similar fashion, as desired.

FIG. 1 illustrates an exemplary, and one of many, embodiment of a vapor compression cooling system 100 utilizing aspects of the present invention. The cooling system 100 generally includes a vapor compression cooling loop 102 comprising a compressor 120, a liquid cooled condenser 130, an expansion mechanism 150, heat exchanger (i.e. evaporator) 160 and transducer 190. In this particular embodiment, the working fluid may be any two-phase refrigerant, such as chloroflourocarbons (CFCs), hydroflourocarbons (HFCS), or hydrochlorofluorocarbon (HCFCs) such as R-22 but not excluding other two-phase refrigerants. Secondary cooling loop 104 comprises a heat exchanger (e.g. a liquid cooler) 170, a flow valve 140 and liquid cooled condenser (i.e. heat exchanger) 130. Cooling system 100 also comprises a control unit 180 that is in communication with valve 140 and transducer 190.

Operation of cooling system 100 may be described as follows. Refrigerant is compressed in the compressor 120, which may be a reciprocating, scroll, or other compressor type, and preferably is a digital scroll compressor, such as those offered by Copeland. After the refrigerant is compressed, it travels through a discharge line 112 to the liquid cooled condenser 130, where heat is removed from the refrigerant. Upon leaving liquid cooled condenser 130, the temperature and/or pressure of the refrigerant is transduced by transducer 190, which may be any type of pressure or temperature transducer known to those of ordinary skill in the art. The refrigerant travels through a first liquid line 114 to an expansion mechanism 150. Expansion mechanism 150 may comprise a valve, orifice or other liquid expansion device known to those of ordinary skill in the art. The expansion mechanism 150 causes a pressure drop in the refrigerant, as the refrigerant passes through the mechanism.

Upon leaving the expansion mechanism, the refrigerant travels through second liquid line 116, arriving at heat exchanger 160. The low-pressure refrigerant absorbs heat from the environment to be cooled. More specifically, air from the environment to be cooled is passed through the evaporator coils so that heat is transferred from the air to the refrigerant. Refrigerant typically as a vapor gas carrying the heat extracted from the environment then returns to the compressor 120 by suction line 118, completing the vapor compression cycle. It will be appreciated that the amount of heat absorbed in the heat exchanger 160 and the amount of heat transferred in the condenser 130 affect how long and how often compressor 120 must run. Therefore, controlling the amount of heat transferred in the liquid cooled condenser 130 directly affects the operation of compressor 120.

In the secondary cooling loop 104, liquid cooled condenser 130 transfers heat from the refrigerant to a cooling fluid, which may be a two-phase refrigerant, glycol, water, or other type of working fluid. In the particular embodiment shown in FIG. 1, the cooling fluid is preferably chilled water. The chilled water passes through the first cooling fluid line 172 to cooling fluid heat exchanger 170 where the heat from the cooling fluid is rejected into the outside environment by any known means, such as one or more cooling fans. Chilled water then travels to valve 140, which may be an electrically controlled motorized ball valve, solenoid proportional valve, globe valve, or pneumatic, digital, hydraulic, analog or other variable flow restricting device known to a person of ordinary skill in the art. Preferably, the valve 140 is a motorized ball valve. The cooling fluid travels through third cooling fluid line 176 and returns to liquid cooled condenser 130 where heat is transferred from the refrigerant to the cooling fluid.

Valve 140 may be controlled manually or by control unit 180. In the preferred embodiment, control unit 180 receives one or more inputs from transducer 190 and outputs one or more control signals to valve 140, such as an actuator (not shown) that controls valve 140. Control unit 180 may use any of a number of control routines to control the valve 140 based on the transduced property of the refrigerant, such as pressure or temperature. Additionally, control unit 180 can be used to control compressor 120. For example, the control unit 180 may instruct the compressor 120, such as a digital scroll compressor, when to cycle on and off.

In the embodiment illustrated in FIG. 1, a control routine is implemented in controller 180 to optimally control cooling system 100. A valve position (or flow volume) control routine may be implemented by control unit 180 to control the opening and closing of valve 140. The control unit 180 and control software may be designed to implement a control strategy that serves to maintain the refrigerant discharge pressure within acceptable or desired limits with minimal valve 140 repositions. A preferred valve position control routine is described below. The routine assumes a variable capacity digital scroll compressor is used as compressor 120.

One of the goals of the valve position control routine is to avoid placing the valve, to the extent possible, into an opening state (where the valve 140 is continuously opening) or into a closing state (where the valve 140 is continuously closing). To accomplish that goal, the control routine may implement a control strategy that makes (or does not make) incremental valve repositions at discrete points in time, such as, for example, generally corresponding to the discrete points in time when the refrigerant pressure is sampled.

Another goal is to avoid startup high pressure conditions by opening valve 140 to a predetermined setpoint before the compressor 120 is started. As described in this embodiment, the start up setpoint is preferably set to 50% (i.e. 50% or 50% of maximum flow) along with a thirty second delay.

Another goal of the preferred valve position control routine is to have an efficient control strategy that can be implemented in a system, like those using a Copeland Digital Scroll® compressor, where the refrigerant pressure is not substantially stable. The pressure is typically always increasing or decreasing and where the instantaneous or near-instantaneous rate of change of the refrigerant pressure does not provide reliable information as to the overall direction of change of the refrigerant pressure. To allow the valve position control routine to operate in such environments, the valve position control routine does not use or rely upon, the rate of change of the refrigerant discharge pressure or whether the discharge pressure is increasing (or not) or decreasing (or not) to control the valve 140.

In general, the preferred valve position control routine samples the refrigerant discharge pressure such as by discharge transducer 190, on a predetermined basis and makes a determination to cause (or not to cause) a valve reposition each time a refrigerant discharge pressure reading is obtained. Alternative embodiments of the valve position control routine may use other properties such as the temperature of the discharge fluid or a combination of temperature and pressure to determine whether to cause (or not to cause) a valve reposition each time a reading is obtained. These alternatives may include using different types of refrigerant which may change the pressure settings.

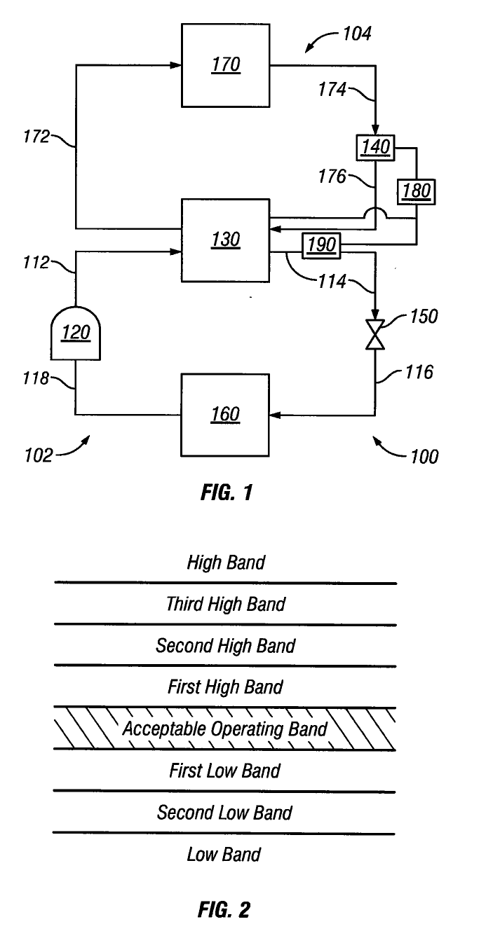

The operation of a preferred valve position control routine may be understood with reference to FIG. 2. Referring to FIG. 2, the valve position control routine operates, in principal, to control the refrigerant discharge pressure (i.e. at the outlet of the heat exchanger 130) such that it remains within an “Acceptable Operating Band.” This may be accomplished in the valve position control routine by defining a plurality of different bands of detected refrigerant discharge pressures and then taking (or not taking) action, depending on where a detected discharge pressure falls within the defined bands.

The first band defined by the valve position control routine may be the Acceptable Operating Band. This band reflects the range of refrigerant discharge pressures within which the system is intended or desired to operate. In the exemplary version of the valve position control routine, the Acceptable Operating Band was set and fixed as the band about between 175 and 210 PSIG. In an another version of the valve position control routine the users of the system will be able to enter a pressure adjustment offset value that will index the operating band by the offset value.

In addition to the Acceptable Operating Band, the valve position control routine defines four bands reflecting discharge pressures above the upper limit of the Acceptable Operating Band. These bands are illustrated in FIG. 2, which is labeled to identify: (i) a First High Band; (ii) a Second High Band; (iii) a Third High Band; and (iv) a High Band. In the exemplary version of the valve position control routine: (ii) a First High Band was set as the band between 210-220 PSIG; (ii) the Second High Band was set as the band between 220-230; (iii) the Third High Band was set as the band between 230-350 PSIG; and (iv) the High Band was set as the band of pressures over 350 PSIG. In another version of the valve position control routine users of the system will be able to enter a pressure adjustment offset value that will index all bands except (iv) High Band by the offset value.

The valve position control routine may also define three bands reflecting discharge pressures below the lower limit of the Acceptable Operating Band. These bands are illustrated in FIG. 2, which is labeled to identify: (i) a First Low Band; (ii) a Second Low Band; and (iii) a Low Band. In the exemplary version of the valve position control routine: (ii) the First Low Band was set as the band between 160-175 PSIG; (ii) the Second Low Band was set as the band between about 100-160 PSIG; and (iii) the Low Band was set as the band below 100 PSIG. In another version of the valve position control routine the users of the system will be able to enter a pressure adjustment offset value that will index all bands except (iii) Low Band by the offset value.

As part of its operation, and to limit the number of repositioning events for valve 140, the valve position control routine keeps track of whether a repositioning event has occurred in the First High Band, the Second High Band and/or the First Low Band.

High Refrigerant Pressure Example. The valve position control routine initially starts under “Initial Conditions” where there are no recorded repositioning events for the First High Band, the Second High Band, and/or the First Low Band. If a detected discharge pressure within the Acceptable Operating Band is detected when the Initial Conditions exist, valve position control routine will take no action with respect to the position of the valve 140 (i.e., the position of the valve 140 will not change in response to that detected pressure).

If, while the Initial Conditions exist, a detected pressure above or below the upper limit of the Acceptable Operating Band is detected, the valve position control routine may or may not reposition the valve 140. The situation of a detected pressure above the Acceptable Operating Band is discussed first.

If, while Initial Conditions exist, a pressure reading is provided that is above the lower limit of the First High Band, the valve position control routine will open the valve 140 an incremental amount of 5% and will record a repositioning event for the First High Band. If, while Initial Conditions exist, a pressure reading is provided that is above the lower limit of the Second High Band, the valve position control routine will open the valve 140 an incremental amount of 5% and will record a repositioning event for the Second High Band. This repositioning, if made, is additive of any repositioning made as a result of the pressure being above the lower limit of the First High Band. Thus, if the detected pressure is at a level above the lower limit of the Second High Band, a 5% incremental opening will occur as a result of the pressure above the lower limit of the First High Band and a further 5% incremental opening will occur as a result of the pressure being above the lower limit of the Second High Band. Under these conditions, a repositioning event will be recorded for both the First High Band and the Second High Band.

If, while Initial Conditions exist, a pressure reading is provided that is above the lower limit of the Third High Band, the valve position control routine will open the valve 140 an incremental amount of 10% and a repositioning event is recorded for the Third High Band. This repositioning, if made, is additive of any repositioning made as a result of the pressure being above the lower limit of the First High Band or the Second High Band. Finally, if, while Initial Conditions exist, a pressure reading is provided that is above the lower limit of the High Band, the valve 140 is opened to its fully open (100%) point.

Once a repositioning event has occurred, such that Initial Conditions no longer exist, the operation of the valve position control routine changes the system such that the number of repositioning events used to bring the refrigerant discharge pressure back to within the Acceptable Operating Band is limited. This is accomplished in the following manner.

If, once a repositioning event has occurred, a pressure is detected that is above the lower limit of the High Band, the valve position control routine will either: (i) open the valve 140 to its fully open (100%) position (if the valve 140 was not at that point) or (ii) take no action if the valve 140 is already at the 100% open position.

If, once a repositioning event has occurred, a pressure is detected that is between the lower and upper limits of the Third High Band, the valve position control routine will open the valve 140 an additional 10% from its previous position (up to the 100% open position). This 10% open repositioning will occur regardless of the status of any prior repositioning events.

If, once a repositioning event has occurred, a pressure is detected that is between the lower and upper limits of the Second High Band, the valve position control routine will take (or not take) action as follows. If there is no recorded repositioning event for the Second High Band when the pressure is detected, the system will open the valve 140 incrementally 5% and will record a Second High Band repositioning event. If there is a recorded repositioning event for the Second High Band, the valve position control routine will take no action and will allow the valve 140 to remain in its existing position.

If, once a repositioning event has occurred, a pressure is detected that is between the lower and upper limits of the First High Band, the valve position control routine will take no action and will allow the valve 140 to remain in its existing position. This is because, under such conditions, a repositioning event would have been recorded for the First high Band.

As the above, indicates, once a repositioning event has occurred, valve position control routine operates such as to avoid placing the valve 140 in an opening state (where the valve 140 is always opening). Specifically, in the valve position control routine, there is only a single, one-time, 5% opening adjustment for a detected pressure within the First High Band, and a single, one-time, 5% opening adjustment for a detected pressure within the Second High Band. After these single, one-time, opening adjustments are made there are no other adjustments made on detected pressure if the detected pressure is within the First High Band or the Second High Band.

As a result of the fact that one opening adjustment is made (based on detected pressure) for detected pressures within the First High Band and the Second High Band, there is the potential in the valve position control routine for the refrigerant discharge pressure to settle at a point within the First High Band and the Second High Band (after the initial opening repositioning are made). To avoid this result, and to move the refrigerant pressure into the Acceptable Operating Band, the valve position control routine uses a timer based control strategy that runs in parallel with the control strategy based on detected pressures, described above.

In accordance with the timer-based control strategy, the valve position control routine sets a five minute timer when a pressure is detected that is above the lower limit of the First High Band. Once set, the timer is reset upon: (i) the occurrence of a repositioning event, or (ii) the detection of a pressure below the lower limit of the First High Band. If this five-minute timer “times out” before it is reset, the valve position control routine will open the valve 140 an additional 5%. In this manner, the refrigerant discharge pressure will be driven towards the Acceptable Operating Range using a limited number of repositioning events.

In addition to the opening repositioning events described above, the valve position control routine may implement, under certain circumstances, a “closing” valve repositioning, accompanied by a clearing of the record of a repositioning for the First High Band or the Second High Band. Specifically, if a pressure is detected that is 5 PSIG below the lower limit of the Second High Band and there is a record of a repositioning for the Second High Band, the valve position control routine will: (i) determine whether to make an adjustment to the valve and (ii) clear the record of the repositioning for the Second High Band. Similarly, if a pressure is detected that is 5 PSIG below the lower limit of the First High Band and there is a record of a repositioning for the First High Band, the valve position control routine will: (i) determine whether to make an adjustment to the valve and (ii) clear the record of the repositioning for the First High Band. Once the records for any repositioning in the Second High Band and the First High Band are cleared, such that there are no records of repositioning, the Initial Conditions will be re-established.

Low Refrigerant Pressure Example. The above discussion concerned the operation of the valve 140 under conditions where the detected refrigerant pressure was above the upper limit of the Acceptable Operating Band. The operation of the system when the pressure is below the lower limit of the Acceptable Operating Band is similar.

Starting at Initial Conditions, the valve position control routine will close valve 140 4% once, for each detected pressure that is below the upper limit of the First Low Band. A record of such repositioning is kept to ensure that one repositioning is made for such a detected pressure. If, after the initial 4% closure is made in response to the detection of pressure below the upper limit of the First Low Band, pressures are detected that are within the First Low Band, no additional closing repositioning will be made.

If a pressure is detected that is below the upper limit of the Second Low Band, the valve position control routine will close the valve 140 5% incrementally (up to a minimum closure at the 25% open point) in response to that detected pressure, regardless of any prior repositioning events.

If a pressure is detected that is below the upper limit of the Low Band, the valve position control routine will close valve 140 to the 25% open position in response to that detection, if the valve 140 is not already at the 25% open position.

In a manner like that described in connection with a high pressure, whenever a pressure below the upper limit of the First Low Band is detected, a five-minute timer is set. The timer will be reset upon: (i) the detection of a pressure above the upper limit of the First Low Band or (ii) a repositioning of the valve 140. In this manner, timer-based repositioning events will drive the refrigerant pressure to within the Acceptable Operating Band.

In addition to the closing repositioning events described above, valve position control routine may implement, under certain circumstances, an “opening” valve repositioning, accompanied by a clearing of the record of a repositioning for the First Low Band or the Second High Band. Specifically, if a pressure is detected that is 5 PSIG above the upper limit of the First Low Band and there is a record of a repositioning for the First Low Band, the valve position control routine will: (i) determine whether to make an adjustment to the valve and (ii) clear the record of the repositioning for the First Low Band.

The operation of the valve position control routine may be improved by using the valve reposition history to indicate system instability and increasing or decreasing the operating bands of the valve position control routine. For example, if a high number of repositions (i.e. ten reposition in ten minutes) are observed and the compressor 120, such as a compressor digital output, is not changing this may indicate a system instability where the valve 140 is opening and closing based on the pressure exceeding the upper and lower thresholds of the operating bands. When this occurs, a way to correct the instability would be to increase the operating bands to reduce valve repositions. For example, the Acceptable Operating Band may be moved from the preferred 175 and 210 PSIG to 165 and 220 PSIG.

Operation of alternative embodiment of a valve position control routine control strategy may be described as follows. The valve repositions are monitored over a time period, such as a rolling half hour time period. The total number of reposition are counted over the time period. The maximum and minimum digital output capacity during this period is monitored. If total repositions is greater than an allowable number of repositions, defaulted at 10, and the maximum and minimum digital output capacity is less than the allowable digital change, defaulted at 20, then the High Band settings may be increased above the setpoint by a set PSI, such as by 5 PSI, and the Low Band settings may be decrease below the setpoint by a set PSI, such as by 5 PSI. The system may then be operated with the adjusted pressure settings until the digital output exceeds the maximum value or drops below the minimum value, or until the compressor is turned off by the call for cooling. This change in the High and Low Band may reduce the valve repositions. The other operating bands may also be changed as well to reduce the valve repositions.

Other and further embodiments of the valve position control routine may be implemented. For example, the system may use the discharge temperature measured by discharge transducer 190 to implement the control strategy. Further, an electronic timing circuit may be designed to control the valve 140 in place of or in addition to the valve position control routine.

The inventions disclosed and taught herein solves the problem with, and problems associated with, the rapid fluctuations of pressure of the fluid flowing through the fluid cooled heat exchanger. For example, the system and method uses a control strategy that eliminates the movements in the valve. The life of the valve is increased due to reduced motor and valve repositions. The cooling system performance improves because pressures and temperatures are more stable. The life of other components that respond to pressure change also increases. It reduces the supply fluid pressure spikes because the valve will never position to full close while system is operating. Servicing the valve does not require opening the refrigerant system.

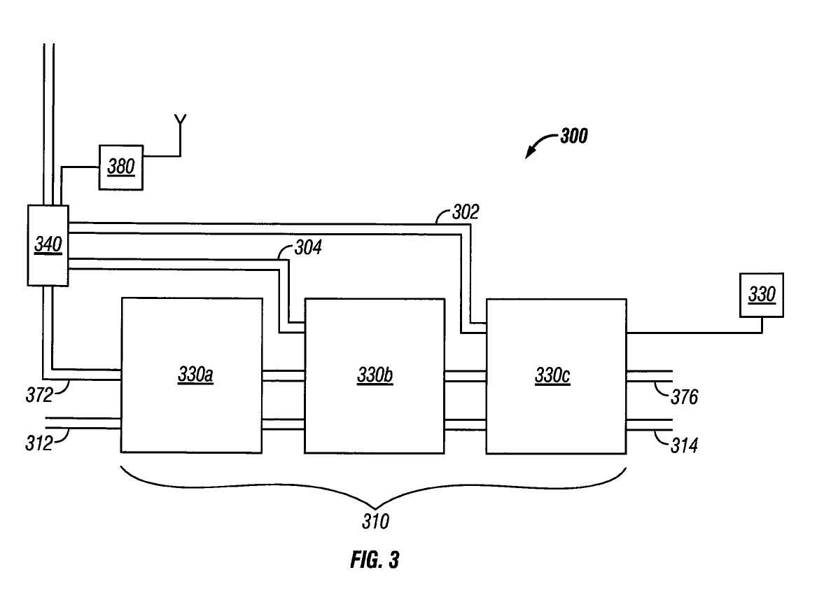

FIG. 3 illustrates alternative embodiment of a vapor compression system utilizing aspects of the present invention. This alternative embodiment controls the cooling capacity by controlling the heat transfer area of the condenser(s). FIG. 3 illustrates a portion of a traditional vapor compression cooling system 300, such as the one describes in FIG. 1, utilizing paradenser 310, for example the Liebert Paradenser®, in the place of condenser 30. A paradenser is a series of condensers, depicted here as condensers 310a, 310b, and 310c. In order to maximize the efficiency of the paradenser and the vapor compression system as a whole, the system is plumbed such that a manifold 340 is adapted to route cooling fluid through one or more of condenser 310a, 310b, or 310c in paradenser 310.

As described above, a control unit 380 may be adapted to control the manifold 340 such that cooling fluid is routed to the condensers as needed to optimize system capacity and/or to match the heat load generated by the space that is being cooled. The control unit 380 can direct cooling fluid flow through first fluid flow line 302 when condensers 330b and 330c are not required to reject heat from the refrigerant. The control unit 380 can direct additional cooling fluid flow through second fluid flow line 304 when condenser 330c is not required to reject heat from the refrigerant. Finally, control unit 380 can direct cooling fluid flow through first cooling fluid line 306 when all three condensers of the paradenser are needed to reject heat from the refrigerant. For example, if the system needed to reject more heat from refrigerant (based on the transduced temperature or pressure of the working fluid), the control unit 380 would direct cooling fluid through condenser 330c and condenser 330b. As more heat rejection was necessary, control unit 380 may additionally direct cooling fluid through condenser 330a. As more cooling fluid flows through more condensers, more heat can be rejected from the refrigerant. The control routine of this embodiment can be based on many system parameters, including, but not limited to, the working fluid temperature or pressures measured through the cooling system; the outdoor temperature measured through the cooling system; the on/off status of a fan; or the digital output of a compressor. This embodiment may be implemented independent of or in conjunction with the valve position control routine described herein.

Other and further embodiments utilizing one or more aspects of the inventions described above can be devised without departing from the spirit of Applicant's invention. For example, instead of using a paradenser to divert the control the cooling fluid flow, a condenser that is divided into several parts can be utilized. The divided condenser may be controlled so that fluid is sent to one or more compartments to maximize the efficiency of the condenser. Also, the controllable manifold may be used on the working fluid side of the system to route working fluid to one or more condenser. Further embodiments include multiple valves in multiple cooling systems controlled by a single controller.

An alternative or supplemental embodiment of the valve position control routine of FIG. 2 may use different system parameters to implement the control strategy. In such alternative or supplemental embodiment, one or more correction factors or valve adjustment factors may be applied to the valve position control routine such as that described with reference to FIG. 2 based on different system parameters, including, but not limited to, discharge temperature; the digital output capacity of the digital compressor 120; return air or supply air conditions, such as the temperature or relative humidity; or coil temperature delta, i.e. the difference between the air temperature entering and leaving the coil. The valve adjustment factor may be used to make the cooling system and operation of the valve more efficient and effective. The adjustment factor may be used to adjust or control the refrigerant discharge pressure into different bands and thus cause or not cause repositioning of the ball valve to create a more efficient cooling system.

The valve adjustment factor may be a combination of several adjustment factors, whereby each adjustment factor is determined based on a different system parameter. For example, the valve adjustment factor may be calculated as follows:

Valve Adjustment Factor=Fluid Temperature Adjustment Factor*Digital Output Adjustment Factor

Once the valve adjustment factor is calculated it can be used to convert the standard valve adjustment as was described above. For example, the actual valve adjustment may be calculated as follows:

Actual Valve Adjustment=Standard Valve Adjustment*Valve Adjustment Factor

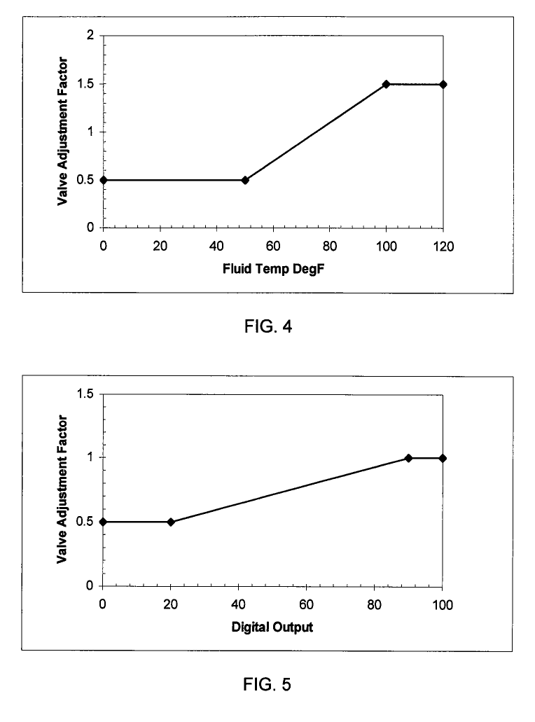

The operation of the alternative or supplemental valve position control routines may be understood with reference to FIGS. 4 and 5. FIG. 4 illustrates an embodiment of the operation of the fluid temperature adjustment factor of the valve position control routine. The fluid temperature adjustment factor can be based on a fluid sensor temperature located anywhere in the system, including but not limited to the discharge transducer 190, such a thermistor located at the second liquid line 116, or any other temperature measurement of the working fluid. The fluid temperature can then be used to apply a correction factor or fluid temperature adjustment factor to the valve position control routine.

As is shown in FIG. 4, as the fluid temperature changes (x-axis), the fluid temperature adjustment factor (y-axis) can be increased or decreased. Fluid temperature ranges would be limited by defining minimum, lower inflection, upper inflection, and maximum fluid temperature points. The Valve Adjustment Factor would also be limited defining minimum, lower inflection, upper inflection, and maximum fluid temperature points. For example, for the Valve Adjustment Factor illustrated in FIG. 4, the minimum may be, for example 0.5, the lower inflection point may be, for example 0.5, the upper inflection point may be, for example 1.5, and the maximum, may be, for example 1.5. Controlling the cooling system with a fluid temperature adjustment can make the cooling system more efficient and responsive. Once the fluid temperature adjustment is calculated based on a fluid temperature, the fluid temperature adjustment factor can then be applied to the Refrigerant Discharge Pressure to make the cooling system more efficient and responsive. Further, the fluid temperature adjustment may be used by itself or in combination with other correction factors to implement the cooling system control strategy.

FIG. 5 illustrates an embodiment of the operation of the digital output adjustment factor of the valve position control routine. The digital output adjustment factor can be based upon the digital capacity output of the digital compressor 120, which may be a reciprocating, scroll, or other compressor type, and preferably is a digital scroll compressor, such as those offered by Copeland. For example, the Copeland Scroll™ compressor provides precise capacity modulation. This Copeland Scroll™ can automatically adjust capacity output to match the heating or cooling demand, reducing start-stop cycles and resulting in enhanced reliability and less compressor wear. The Copeland Scroll™ compressor can modulate capacity between 10-100 percent. As is shown in FIG. 5, as the digital output of the digital compress (x-axis) changes, the digital output adjustment factor (y-axis) can be increased or decreased. Once the digital output is calculated based on a digital output of the compressor, the digital output factor can then be applied to the Refrigerant Discharge Pressure to make the cooling system more efficient and responsive. Further, the digital output adjustment factor may be used by itself or in combination with other correction factors to implement the control strategy.

Similar valve adjustments may be made based on return air or supply air conditions, such as temperate and relative humidity, or based on change in the air coil temperature entering and leaving the coil.

Other and further embodiments of the valve position control routine may be implemented. For example, the system may use in combination (i) the fluid temperature sensor discussed above, (ii) the outdoor temperature sensor located at the input to the heat exchanger 160, which is depicted in this embodiment as an air-to-fluid heat exchanger; and (iii) a fan cycling monitor (not shown) located on the fan of the air-to-fluid evaporator to implement the control strategy. Under this embodiment of the control strategy, the control strategy anticipates changes in the cooling system including change in the fluid temperature or pressure.

For example, the outdoor fluid cooler fan turning off can cause the fluid temperature to rise. The fan turning on can cause the fluid temperature to fall. The fluid temperature change can cause the system pressure to increase or decrease which can result in the repositioning of the motorized ball valve. Based on the amount of temperature change the control strategy can decide whether to open or close the valve. Because the control strategy may know when the fan turns on or off the valve can be adjusted before the temperature change occurs which can improve system response.

Operation of fluid temperature change anticipation control strategy may be described as follows. Parameters are included to open or close the valve based on a Temperature Rise Preset or Temperature Fall Preset value. Both values can be set to a certain percentage change, such as five percent. The outdoor temperature and fluid temperature are recorded when fan changes states from either an on state or an off state. When the fan turns on or off the valve can be adjusted before the temperature change occurs which can improve system response.

For example, if a total temperature change greater than ten degrees Fahrenheit is observed in ten minutes the control records the digital output and sets the Temperature Rise Preset or Temperature Fall Preset to active. These values may be adjusted to take into account many factors including the cooling unit, cooling area, and outdoor temperature. As long as the digital output does not change more than +/−5% and the outdoor temperature does not change more than five degrees Fahrenheit (adjustable) the Temperature Rise Preset or Temperature Fall Preset remain active. While the Temperature Rise Preset is active, as soon as the outdoor fluid cooler fan turns off the valve is opened the preset value (5%). While the Temperature Fall Preset is active, as soon as the outdoor fluid cooler fan turns on the valve is closed the preset value (5%). All of the values can be adjusted to take into account many factors including the cooling unit, cooling area, and outdoor temperature. Further embodiments to the fluid temperature change anticipation control strategy may include measuring the time difference from when the fan cycles to when the temperature change occurs at the unit and adjusting the timing of the valve reposition based on this time change.

Further, the various methods and embodiments of the system and method of controlling a fluid flow through a fluid cooled heat exchanger can be included in combination with each other to produce variations of the disclosed methods and embodiments. Discussion of singular elements can include plural elements and vice-versa.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to fully protect all such modifications and improvements that come within the scope or range of equivalent of the following claims.

What is claimed is:

1. A method of controlling a vapor compression cooling system comprising:
operating a vapor compression cooling cycle comprising a condenser and a working fluid;
determining a temperature of the working fluid; and
changing a valve position in response to the temperature to control a flow of cooling fluid through the condenser.

2. The method of claim 1 wherein the temperature of the working fluid is determined at the output of the condenser.

3. The method of claim 1 wherein the temperature of the working fluid is determined at the input of the evaporator.

4. The method of claim 1 wherein the temperature of the working fluid is determined at the input of the evaporator.

5. A method of controlling a vapor compression cooling system comprising:
operating a vapor compression cooling cycle comprising a condenser;
determining a digital capacity output of the compressor; and
changing a valve position in response to the digital capacity output to control a flow of cooling fluid through the condenser.

6. A vapor compression cooling system comprising:
a vapor compression cooling cycle comprising a condenser and a working fluid;
a condenser cooling cycle comprising a fluid control valve adapted to vary a cooling fluid flow through the condenser;
a transducer associated with the condenser and adapted to transduce either pressure or temperature of the working fluid; and
a controller adapted to vary the position of the fluid control valve in response to the transduced pressure or temperature.

7. A vapor compression cooling system comprising:
a vapor compression cooling cycle comprising a condenser and a working fluid;
a condenser cooling cycle comprising a fluid control valve adapted to vary a cooling fluid flow through the condenser and a fan;
a transducer associated with the condenser and adapted to transduce either pressure or temperature of the working fluid;
an outdoor temperature sensor associated with the condenser cooling cycle adapted to sense the outdoor temperature;
a fan cycling monitoring adapted to determine the on/off status of the fan; and
a controller adapted to vary the position of the fluid control valve in response to the transduced pressure or temperature, the outdoor temperature sensor; or the on/off status of the fan.

8. The vapor compression cooling system of claim 4 wherein the controller is adapted to vary the position of the fluid control valve using incremental valve repositions at discrete points in time in response to the transduced pressure or temperature, the outdoor temperature sensor; or the on/off status of the fan.

9. A method of controlling a vapor compression cooling system comprising:
operating a vapor compression cooling cycle comprising one or more condensers;
determining a pressure or temperature of a fluid leaving the one or more condensers; and
changing the heat transfer area in response to the pressure or temperature.

10. The method of claim 9, further comprising the step of changing the heat transfer area in response to the outdoor temperature sensor; or the on/off status of the fan.

11. A vapor compression cooling system comprising:
a vapor compression cooling cycle comprising one or more condensers and a working fluid;
a condenser cooling cycle comprising a fluid control valve adapted to vary a cooling fluid flow through the one or more condensers;
a transducer associated with the condenser and adapted to transduce either pressure or temperature of the working fluid;
an outdoor temperature sensor associated with the condenser cooling cycle adapted to sense the outdoor temperature;
a fan cycling monitoring adapted to determine the on/off status of the fan;
a system associated with the one or more condensers and adapted to direct cooling fluid flow through one or more condensers; and
a controller adapted to vary the fluid flow through the one or more condensers to change the heat transfer area.

12. The vapor compression system of claim 8 wherein the system is a manifold.

13. A method of controlling a vapor compression cooling system comprising:
operating a vapor compression cooling cycle comprising one or more condensers;
determining a pressure or temperature of a fluid leaving the one or more condensers;
determining a temperature of in the environment surrounding the vapor compression cooling system;
changing a valve position in response to the pressure, temperature of a fluid, or the temperature of the environment surrounding the vapor compression cooling system to control a flow of cooling fluid through the on or more condensers; and

14. The method of claim 13 further comprising changing the heat transfer area in response to the pressure or temperature.

15. A vapor compression cooling system comprising:
a vapor compression cooling cycle comprising one or more condenser and a working fluid;
a condenser cooling cycle comprising a fluid control valve adapted to vary a cooling fluid flow through the one or more condenser;
a transducer associated with the one or more condenser sand adapted to transduce either pressure or temperature of the working fluid; and
a controller adapted to vary the position of the fluid control valve in response to the transduced pressure, temperature, or output capacity of condenser and/or vary the fluid flow through the one or more condensers to change the heat transfer area.
